(19) United States
(12) Patent Application Publication
(10) Pub. No.: US 2024/0381348 A1
(43) Pub. Date: Nov. 14, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/656,605

(22) Filed: May 7, 2024

(30) Foreign Application Priority Data
May 11, 2023 (CN) 202310532853.9
May 16, 2023 (CN) 202310552491.X

(51) Int. Cl. H04W 72/1268; H04L 1/1607; H04W 72/0446; H04W 72/20

(52) U.S. Cl. CPC H04W 72/1268; H04L 1/1614; H04W 72/0446; H04W 72/20

(57) ABSTRACT

Present application discloses a method and a device in a communication node for wireless communications. The communication node receives a first message, the first message configuring uplink grants, any two uplink grants configured by the first message being temporally non-overlapped; and receives a second message, the second message indicating a first symbol set; and transmits first control information in a first uplink grant, the first control information indicating whether K2 uplink grant(s) is(are) unused, the first uplink grant and the K2 uplink grant(s) being configured by the first message, the K2 uplink grant(s) being after the first uplink grant; the K2 uplink grant(s) is(are) dependent on at least a former of a time-domain location of the uplink grants configured by the first message or a location of the first symbol set; K2 being a positive integer. The scheme improves the effectiveness of information indicated by the first control information.

### CROSS REFERENCE TO RELATED APPLICATIONS

This application claims the priority benefit of Chinese Patent Application No. 202310532853.9, filed on May 11, 2023, and claims the priority benefit of Chinese Patent Application No. 202310552491.X, filed on May 16, 2023, the full disclosure of which is incorporated herein by reference.

### BACKGROUND

### Technical Field

The present application relates to transmission methods and devices in wireless communication systems, and in particular to a method and a device for indicating control information.

### Related Art

Application scenarios of future wireless communication systems are becoming increasingly diversified, and different application scenarios have placed the performance requirement of high speed and low latency on the systems. For example, in order to meet the different performance requirements of multiple application scenarios, such as capacity requirements, the Work Item (WI) of “XR Enhancements for NR (where XR refers to Extended Reality, and NR refers to New Radio)” was adopted at the 3rd Generation Partner Project (3GPP) #98 Plenary Meeting.

### SUMMARY

The inventors have found through researches that the indication of control information is a key problem.

In response to the above problem, the present application provides a solution for the indication of control information. In the description of the problem described above, an NR system is used as an example, and the present application is equally applicable to, for example, scenarios of LTE (i.e., Long-Term Evolution) or LTE-A (i.e., Long-Term Evolution Advanced) systems to achieve technical effects similar to those of the NR system; and further. Although the present application offers specific methods of implementation for uplink, the present application can also be used, for example, in downlink scenarios to achieve technical results similar to those of uplink. Further, using a unified design scheme for different scenarios also helps to reduce hardware complexity and cost. Further, although the present application gives specific implementations for XR scenarios, the present application can also be used in uplink enhancement scenarios to achieve technical effects similar to XR systems. Further, while the present application gives specific implementations for Physical Uplink Shared Channel (PUSCH), the present application can also be used in scenarios such as PRACH or PUCCH or PUSCH repetition to achieve PUSCH-like technical effects. Further, although the original intent of the present application was for Uu air interface, the present application can also be used for PC5 interface to achieve technical effects similar to Uu air interface. Further, although the original intent of the present application is for terminal-base station scenarios, the present application can also be used in V2X (i.e., Vehicle-to-Everything) scenarios, communication between the terminal and the relay, and between the relay and the base station, to achieve technical effects similar to those in the terminal-base station scenarios. Further, although the original intent of the present application is for the terminal-base station scenario, the present application is equally applicable to the IAB (i.e., Integrated Access and Backhaul) communication scenario, for obtaining technical effects similar to those in the terminal-base station scenario. Further, although the present application is intended for Terrestrial Network (TN) scenarios, the present application is also applicable to Non-Terrestrial Network (NTN) communication scenarios, where technical effects similar to those in TN scenarios can be achieved. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

receiving a first message, the first message configuring uplink grants, any two uplink grants configured by the first message being temporally non-overlapped; and receiving a second message, the second message indicating a first symbol set; and

transmitting first control information in a first uplink grant, the first control information indicating whether K2 uplink grant(s) is(are) unused, the first uplink grant and the K2 uplink grant(s) being configured by the first message, the K2 uplink grant(s) being after the first uplink grant;

typically, the K2 uplink grant(s) is(are) dependent on a time-domain location of uplink grants configured by the first message; K2 being a positive integer.

Typically, the K2 uplink grant(s) is(are) dependent on a time-domain location of uplink grants configured by the first message and a location of the first symbol set; K2 being a positive integer.

In one embodiment, a problem to be solved in the present application includes: the first control information indicates which of uplink grants are unused.

In one embodiment, a problem to be solved in the present application includes: the first control information indicates how many uplink grants are unused.

In one embodiment, characteristics of the above method include: location(s) of the K2 uplink grant(s) is(are) dependent on at least a former of a time-domain location of uplink grants configured by the first message or a location of the first symbol set.

In one embodiment, characteristics of the above method include: K2 is dependent on at least a former of a time-domain location of uplink grants configured by the first message or a location of the first symbol set.

In one embodiment, an advantage of the above method includes: reducing the impact on the first symbol set.

In one embodiment, an advantage of the above method includes: saving signaling overhead.

In one embodiment, an advantage of the above method includes: increasing the effectiveness of information indicated by the first control information.

According to one aspect of the present application, characterized in that the K2 uplink grant(s) is(are) dependent on a first time interval; a start of the first time interval is related to a time-domain location of the first uplink grant, and a length of the first time interval is configurable.

In one embodiment, an advantage of the above method includes: reducing unnecessary indications.

According to one aspect of the present application, characterized in that the first control information is a bitmap, a number of bits occupied by the first control information is greater than K2, and at least one bit in the first control information is reserved.

In one embodiment, an advantage of the above method includes: reducing unnecessary indications.

In one embodiment, an advantage of the above method includes: reducing the influence on existing protocols.

In one embodiment, an advantage of the above method includes: reducing the implementation complexity.

According to one aspect of the present application, characterized in that the K2 uplink grant(s) is(are) dependent on the number of bits occupied by the first control information; the first control information is a bitmap.

According to one aspect of the present application, characterized in that the K2 uplink grant(s) is(are) valid uplink grant(s); the valid uplink grant(s) satisfies/satisfy at least one condition of being non-overlapped with the first symbol set or belonging to the first time interval or being later than the first uplink grant in time domain.

In one embodiment, an advantage of the above method includes: reducing the influence on existing protocols.

In one embodiment, an advantage of the above method includes: reducing the implementation complexity.

The present application provides a method in a second node for wireless communications, comprising:
transmitting a first message, the first message configuring uplink grants, any two uplink grants configured by the first message being temporally non-overlapped; and transmitting a second message, the second message indicating a first symbol set; and
receiving first control information, the first control information indicating whether K2 uplink grant(s) is(are) unused, the first uplink grant and the K2 uplink grant(s) being configured by the first message, the K2 uplink grant(s) being after the first uplink grant;
herein, a receiver of the first message transmits the first control information in a first uplink grant; the K2 uplink grant(s) is(are) dependent on at least a former of a time-domain location of uplink grants configured by the first message or a location of the first symbol set; K2 being a positive integer.

According to one aspect of the present application, characterized in that the K2 uplink grant(s) is(are) dependent on a first time interval; a start of the first time interval is related to a time-domain location of the first uplink grant, and a length of the first time interval is configurable.

According to one aspect of the present application, characterized in that the first control information is a bitmap, a number of bits occupied by the first control information is greater than K2, and at least one bit in the first control information is reserved.

According to one aspect of the present application, characterized in that the K2 uplink grant(s) is(are) dependent on the number of bits occupied by the first control information; the first control information is a bitmap.

According to one aspect of the present application, characterized in that the K2 uplink grant(s) is(are) valid uplink grant(s); the valid uplink grant(s) satisfies/satisfy at least one condition of being non-overlapped with the first symbol set or belonging to the first time interval or being later than the first uplink grant in time domain.

The present application provides a first node for wireless communications, comprising:
a first receiver, receiving a first message, the first message configuring uplink grants, any two uplink grants configured by the first message being temporally non-overlapped; and receiving a second message, the second message indicating a first symbol set; and
a first transmitter, transmitting first control information in a first uplink grant, the first control information indicating whether K2 uplink grant(s) is(are) unused, the first uplink grant and the K2 uplink grant(s) being configured by the first message, the K2 uplink grant(s) being after the first uplink grant;
herein, the K2 uplink grant(s) is(are) dependent on at least a former of a time-domain location of uplink grants configured by the first message or a location of the first symbol set; K2 being a positive integer.

The present application provides a second node for wireless communications, comprising:
a second transmitter, transmitting a first message, the first message configuring uplink grants, any two uplink grants configured by the first message being temporally non-overlapped; and transmitting a second message, the second message indicating a first symbol set; and
a second receiver, receiving first control information, the first control information indicating whether K2 uplink grant(s) is(are) unused, the first uplink grant and the K2 uplink grant(s) being configured by the first message, the K2 uplink grant(s) being after the first uplink grant;
herein, a receiver of the first message transmits the first control information in a first uplink grant; the K2 uplink grant(s) is(are) dependent on at least a former of a time-domain location of uplink grants configured by the first message or a location of the first symbol set; K2 being a positive integer.

In one embodiment, compared with the prior art, the present application is advantageous in at least one of the following aspects:
reducing the impact on the first symbol set;
reducing the signaling overhead;
increasing the effectiveness of information indicated by the first control information;
reducing unnecessary indications;
reducing impact on existing protocols;
reducing implementation complexity.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first message, a second message and first control information according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of K2 uplink grant(s) depending on a first time interval according to one embodiment of the present application.

FIG. 7 illustrates a schematic diagram of K2 uplink grant(s) being valid uplink grant(s) according to one embodiment of the present application.

FIG. 8 illustrates a schematic diagram of at least one bit in first control information being reserved according to one embodiment of the present application.

FIG. 9 illustrates a schematic diagram of uplink grants configured by a first message and a first symbol set according to one embodiment of the present application.

FIG. 10 illustrates a schematic diagram of K2 depending on a time-domain location of uplink grants configured by a first message according to one embodiment of the present application.

FIG. 11 illustrates a schematic diagram of K2 uplink grant(s) depending on a time-domain location of uplink grants configured by a first message according to one embodiment of the present application.

FIG. 12 illustrates a structure block diagram of a processing device used in a first node according to one embodiment of the present application.

FIG. 13 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

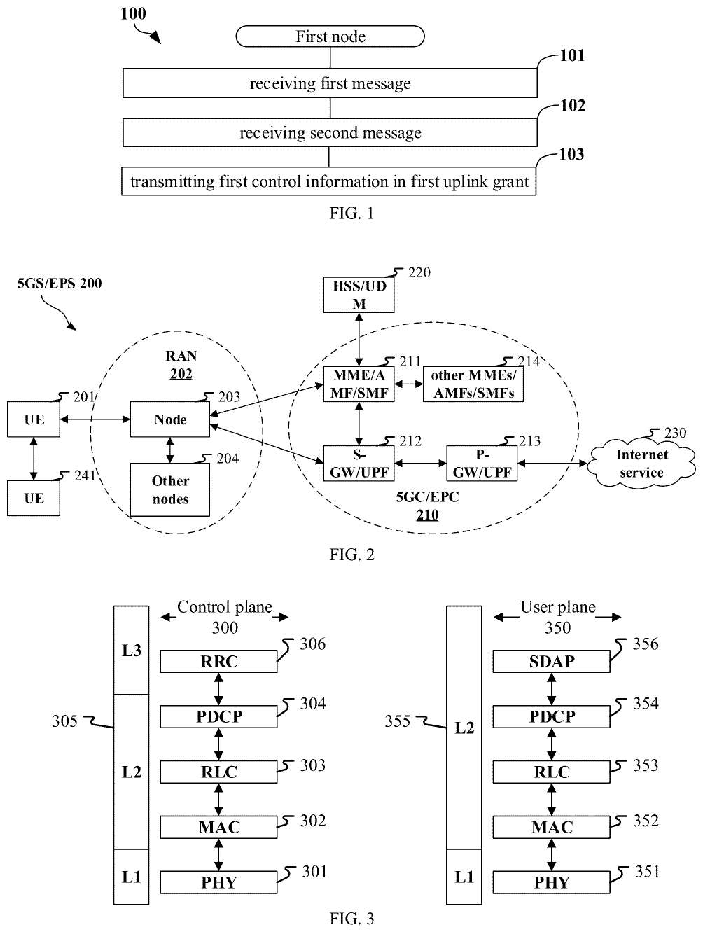

Embodiment 1 illustrates a flowchart of transmission of a first message, a second message and first control information according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in this application receives a first message in step 101, the first message configuring uplink grants, any two uplink grants configured by the first message being temporally non-overlapped; and receives a second message in step 102, the second message indicating a first symbol set; and transmits first control information in a first uplink grant in step 103, the first control information indicating whether K2 uplink grant(s) is(are) unused, the first uplink grant and the K2 uplink grant(s) being configured by the first message, the K2 uplink grant(s) being after the first uplink grant; herein, the K2 uplink grant(s) is(are) dependent on at least a former of a time-domain location of uplink grants configured by the first message or a location of the first symbol set; K2 being a positive integer.

In one embodiment, the first message is a UE-specific signaling

In one embodiment, the first message is a Cell common signaling.

In one embodiment, the first message is used for configuring Configured Grant.

In one embodiment, the first message is used for configuring semi-persistently.

In one embodiment, the first message is a Layer 1 (L1) signaling.

In one embodiment, the first message is transmitted via a physical downlink control channel (PDCCH).

In one embodiment, the first message is a piece of Downlink control information (DCI).

In one embodiment, a DCI format of the first message is DCI format 0_0.

In one embodiment, a DCI format of the first message is DCI format 0_1.

In one embodiment, a DCI format of the first message is DCI format 0_2.

In one embodiment, a DCI format of the first message is a new DCI format.

In one embodiment, the first message comprises at least one field in a DCI format.

In one embodiment, the first message is a DCI with Cyclic redundancy check (CRC) scrambled by a Configured Scheduling (CS)—Radio Network Temporary Identity (RNTI).

In one embodiment, the first message is a Radio Resource Control (RRC) Message.

In one embodiment, the first message is an RRCReconfiguration message.

In one embodiment, the first message is a CellGroupConfig IE.

In one embodiment, the first message comprises an IE that includes ConfiguredGrantConfig in its name.

In one embodiment, the first message is a ConfiguredGrantConfig IE.

In one embodiment, the first message comprises one field, the one field indicating a first index.

In one subembodiment, a name of the one field includes configuredGrantConfiglndex.

In one subembodiment, the one field is a configuredGrantConfiglndex field.

In one subembodiment, a name of the one field includes configuredGrantConfigIndexMAC.

In one subembodiment, the one field is a configuredGrantConfiglndex field.

In one subembodiment, the first index is used to indicate a CG configuration.

In one subembodiment, the first index is used to indicate a CG configuration to which an uplink grant configured by the first message belongs.

In one subembodiment, the first index is associated with a CG configuration to which an uplink grant configured by the first message belongs.

In one embodiment, the first message comprises one field, the one field indicating an offset.

In one subembodiment, the offset is used to determine a time interval in time domain between any two adjacent uplink grants configured by the first message.

In one subembodiment, the offset is a time interval between an end time of one uplink grant configured by the first message and a start time of another uplink grant configured by the first message immediately following the one uplink grant configured by the first message.

In one subembodiment, the offset is used to determine a time interval between slots respectively occupied by any two adjacent uplink grants configured by the first message.

In one subembodiment, the offset is a time interval between a last slot occupied by one uplink grant configured by the first message and a first slot occupied by another uplink grant configured by the first message immediately following the one uplink grant configured by the first message

In one subembodiment, the offset is a non-negative number.

In one subembodiment, the offset is a positive number.

In one subembodiment, the offset is a non-negative integer.

In one subembodiment, the offset is a positive integer.

In one subembodiment, the offset is measured in the unit of slot.

In one subembodiment, the offset is measured in the unit of millisecond (ms).

In one subembodiment, the offset is measured in the unit of 0.5 slot.

In one subembodiment, the offset is measured in the unit of 0.5 ms.

In one embodiment, the first message configures an uplink grant in one configuration period.

In one embodiment, the first message configures uplink grants in a plurality of consecutive configuration periods.

In one embodiment, the first message configures uplink grants in at least one consecutive configuration period.

In one embodiment, uplink grants configured by the first message are correlated.

In one embodiment, at least two of uplink grants configured by the first message are uncorrelated.

In one embodiment, uplink grants configured by the first message are for a same Medium Access Control (MAC) entity.

In one embodiment, uplink grants configured by the first message are for a same UL Bandwidth Part (BWP).

In one embodiment, uplink grants configured by the first message occupy PUSCH resources.

In one embodiment, the type of the uplink grants configured by the first message is configured grant Type 1.

In one embodiment, the type of the uplink grants configured by the first message is configured grant Type 2.

In one embodiment, uplink grants configured by the first message are used for data transmission in an Uplink Shared Channel (UL-SCH).

In one embodiment, uplink grants configured by the first message belong to a same CG configuration.

In one embodiment, uplink grants configured by the first message belong to a same configuration period.

In one embodiment, the first message is used to determine a start of each configuration period.

In one embodiment, the first message is used to determine a duration of each configuration period.

In one embodiment, the first message is used to determine a number of transmission occasions in each configuration period.

In one embodiment, the first message is used to determine a time interval between adjacent transmission occasions in each configuration period.

In one embodiment, the first message configures at least one configuration period, each configuration period of the at least one configuration period comprising at least one uplink grant.

In one embodiment, the first message configures at least one configuration period, each configuration period of the at least one configuration period comprising at least one uplink grant.

In one embodiment, the first message is used to determine a CG configuration, the CG configuration comprising at least one configuration period, each configuration period of the at least one configuration period comprising at least one uplink grant.

In one embodiment, a number of uplink grants included in one configuration period is configurable.

In one embodiment, a number of uplink grants included in one configuration period is predefined.

In one embodiment, a number of uplink grants included in one configuration period is fixed.

In one embodiment, a number of uplink grants included in one configuration period is explicitly indicated by an RRC message.

In one embodiment, a number of uplink grants included in one configuration period is implicitly indicated by an RRC message.

In one embodiment, one configuration period is a configuration period of a CG.

In one embodiment, one configuration period is a configuration period in a CG configuration.

In one embodiment, the uplink grants in one configuration period have at least one of the same MCS or the same frequency-domain resources or the same PUSCH duration.

In one embodiment, uplink grants configured by the first message are a plurality of contiguous PUSCH resources in a plurality of configuration periods.

In one embodiment, uplink grants configured by the first message are a plurality of discontinuous PUSCH resources in a plurality of configuration periods.

In one embodiment, uplink grants configured by the first message belong to a plurality of configuration periods.

In one embodiment, uplink grants configured by the first message belong to consecutive configuration periods.

In one embodiment, uplink grants configured by the first message belong to a maximum of M1 configuration period(s); M1 being a positive integer.

In one embodiment, the K2 uplink grant(s) belongs/belong to uplink grants in a same configuration period configured by the first message.

In one embodiment, the K2 uplink grant(s) belongs/belong to uplink grants in a plurality of configuration periods configured by the first message.

In one embodiment, the K2 uplink grant(s) belongs/belong to uplink grants in at least one configuration period configured by the first message.

In one embodiment, the K2 uplink grant(s) belongs/belong to at most M1 configuration period(s); M1 being a positive integer.

In one embodiment, the K2 uplink grant(s) belongs/belong to M1 configuration period(s); M1 being a positive integer.

In one embodiment, M1 is predefined.

In one embodiment, M1 is configurable.

In one embodiment, M1 is fixed.

In one embodiment, M1 is 2.

In one embodiment, M1 is 1.

In one embodiment, the M1 configuration periods are adjacent.

In one embodiment, each uplink grant configured by the first message is a UL grant.

In one embodiment, each uplink grant configured by the first message is part of a UL grant.

In one embodiment, each uplink grant configured by the first message is a Transmission Occasion (TO).

In one embodiment, each uplink grant configured by the first message is a Transmission Occasion (TO) in a configuration period.

In one embodiment, each uplink grant configured by the first message is an uplink (UL) resource block (RB).

In one embodiment, each uplink grant configured by the first message is a Physical uplink shared channel (PUSCH) resource.

In one embodiment, each uplink grant configured by the first message occupies a PUSCH resource.

In one embodiment, each uplink grant configured by the first message occupies a PUSCH occasion.

In one embodiment, each uplink grant configured by the first message corresponds to a PUSCH duration.

In one embodiment, each uplink grant configured by the first message corresponds to a PUSCH transmission.

In one embodiment, each uplink grant configured by the first message is configured with an index.

In one subembodiment, the index is unique within a configuration period.

In one subembodiment, the index is used to identify an uplink grant within a configuration period.

In one embodiment, at least one symbol is included between any two adjacent configuration periods.

In one embodiment, no symbol is included between any two adjacent configuration periods.

In one embodiment, any two uplink grants configured by the first message do not include a same time-domain resource.

In one embodiment, any two uplink grants configured by the first message are not allocated the same time-domain resources.

In one embodiment, any two uplink grants configured by the first message do not include a same symbol.

In one embodiment, any one symbol does not belong to any two uplink grants configured by the first message at the same time.

In one embodiment, for two adjacent uplink grants configured by the first message, an end time of an earlier one of the uplink grants in time domain is earlier than a start time of a later one of the uplink grants in time domain.

In one embodiment, for two adjacent uplink grants configured by the first message, at least one symbol is included between an end time of an earlier one of the uplink grants in time domain and a start time of a later one of the uplink grants in time domain.

In one embodiment, for two adjacent uplink grants configured by the first message, no symbol is included between an end time of an earlier one of the uplink grants in time domain and a start time of a later one of the uplink grants in time domain.

In one embodiment, any two uplink grants configured by the first message being temporally non-overlapped means: PUSCH durations of the any two uplink grants configured by the first message are non-overlapping in time.

In one embodiment, the first symbol set is at least one symbol.

In one embodiment, the first symbol set is at least one symbol consecutive in time domain.

In one embodiment, the first symbol set is a plurality of symbols consecutive in time domain.

In one embodiment, the first symbol set is all symbols in one slot.

In one embodiment, the first symbol set is part of symbols in one slot.

In one embodiment, the first symbol set belongs to the same slot.

In one embodiment, the first symbol set belongs to at least one slot.

In one embodiment, the first symbol set belongs to more than one slot.

In one embodiment, the first symbol set is not continuous in time domain.

In one embodiment, whether the first symbol set is contiguous in time domain is configurable.

In one embodiment, the first symbol set is a time-domain resource configured by the second message.

In one embodiment, the first symbol set is a time-domain resource determined by the second message.

In one embodiment, the first symbol set is a time-domain resource activated by the second message.

In one embodiment, the first symbol set is a time-domain resource configured and activated by the second message.

In one embodiment, the first symbol set is a time-domain resource corresponding to a time-frequency resource assigned to the sidelink.

In one embodiment, the above method reduces the impact on sidelink communication.

In one embodiment, the first symbol set is used for network energy saving.

In one embodiment, the first symbol set is an inactive time for cell Discontinuous Reception/Discontinuous Transmission (DRX/DTX).

In one embodiment, the first symbol set is a time while a timer is running.

In one embodiment, the first symbol set is a time while a ra-ResponseWindow is running.

In one embodiment, the first symbol set is a time while a msgB-ResponseWindow is running.

In one embodiment, the first symbol set is a time while a ra-ContentionResolutionTimer is running.

In one embodiment, the second message is an RRC message.

In one embodiment, the second message comprises at least one RRC message.

In one embodiment, the second message comprises at least one RRC IE.

In one embodiment, the second message comprises at least one RRC field.

In one embodiment, the second message comprises at least one signaling of protocol layers below the RRC protocol layer.

In one embodiment, the second message is at least one signaling of protocol layers below the RRC protocol layer.

In one embodiment, the second message configures the first symbol set.

In one embodiment, the second message is used to determine the first symbol set.

In one embodiment, the second message configures and activates the first symbol set.

In one embodiment, the second message comprises at least one RRC message, the at least one RRC message being used to configure the first symbol set; the second message comprises at least one signaling of protocol layers below the RRC protocol layer, the at least one signaling of protocol layers below the RRC protocol layer being used to activate the first symbol set.

In one embodiment, the second message indicates the first symbol set in a time-domain resource for downlink transmission.

In one subembodiment, the time-domain resource for downlink transmission is downlink slot(s).

In one subembodiment, the time-domain resource for downlink transmission is flexible slot(s).

In one subembodiment, the time-domain resource for downlink transmission is at least one downlink slot or flexible slot.

In one subembodiment, each symbol in the first symbol set is configured for subband non-overlapping full duplex (SBFD).

In one subembodiment, a System Information Block 1 (SIB1) is used to configure the time-domain resource for downlink transmission.

In one subembodiment, a ServingCellConfigCommon IE is used to configure the time-domain resource for downlink transmission.

In one subembodiment, a ServingCellConfigCommonSIB IE is used to configure the time-domain resource for downlink transmission.

In one subembodiment, a BWP-Uplink IE is used to configure the time-domain resource for downlink transmission.

In one subembodiment, a BWP-UplinkCommon IE is used to configure the time-domain resource for downlink transmission.

In one subembodiment, a tdd-UL-DL-ConfigurationCommon field is used to configure the time-domain resource for downlink transmission.

In one subembodiment, an RRC field that includes tdd-UL-DL-ConfigurationCommon in its name is used to configure the time-domain resource for downlink transmission.

In one subembodiment, a TDD-UL-DL-ConfigCommon IE is used to configure the time-domain resource for downlink transmission.

In one subembodiment, a TDD-UL-DL-Pattern IE is used to configure the time-domain resource for downlink transmission.

In one subembodiment, a TDD-UL-DL-ConfigDedicated IE is used to configure the time-domain resource for downlink transmission.

In one embodiment, the first symbol set is an activated measurement gap.

In one subembodiment, the method reduces the impact on the activated measurement gap.

In one subembodiment, the first symbol set is a duration of an activated measurement gap.

In one subembodiment, the first symbol set is a time-domain resource occupied by an activated measurement gap.

In one subembodiment, the first symbol set is configured to a duration of an activated measurement gap.

In one subembodiment, the activated measurement gap is used to perform a measurement.

In one subembodiment, the activated measurement gap is a Frequency range 1 (FR1) measurement gap.

In one subembodiment, the activated measurement gap is a Frequency range 2 (FR2) measurement gap.

In one subembodiment, a frequency-domain resource corresponding to the activated measurement gap is overlapped with a frequency-domain resource for the uplink grants configured by the first message.

In one subembodiment, a frequency-domain resource corresponding to the activated measurement gap belongs to a frequency-domain resource for the uplink grants configured by the first message.

In one subembodiment, a frequency-domain resource for the uplink grants configured by the first message belongs to a frequency-domain resource corresponding to the activated measurement gap.

In one subembodiment, a frequency-domain resource corresponding to the activated measurement gap and a frequency-domain resource for the uplink grants configured by the first message are non-overlapped.

In one embodiment, the first symbol set is a time-domain resource assigned to a candidate uplink grant.

In one subembodiment, the first symbol set is a PUSCH duration assigned to a candidate uplink grant.

In one subembodiment, the candidate uplink grant is addressed to a Temporary C-RNTI.

In one subembodiment, the method above reduces the impact on random access.

In one subembodiment, the candidate uplink grant is dynamically received on a PDCCH.

In one subembodiment, the candidate uplink grant is received in a Random Access Response (RAR).

In one subembodiment, the method above reduces the impact on random access.

In one subembodiment, the candidate uplink grant is configured semi-persistently by the RRC signaling.

In one subembodiment, the candidate uplink grant is determined based on PUSCH resources associated to a Message A (MSGA).

In one subembodiment, the method above reduces the impact on random access.

In one subembodiment, the candidate uplink grant is a Dynamic Grant (DG).

In one subembodiment, the above method reduces the impact on dynamically scheduled uplink grants.

In one subembodiment, the candidate uplink grant is a CG; the CG is not an uplink grant among the uplink grants configured by the first message.

In one subembodiment, the candidate uplink grant has a higher priority than the target uplink grant.

In one subembodiment, the method above reduces the impact on the uplink grant with higher priority.

In one subembodiment, a MAC entity of the first node is configured with lch-basedPrioritization.

In one subembodiment, a MAC entity of the first node is not configured with lch-basedPrioritization.

In one subembodiment, a MAC entity of the first node is configured with lch-basedPrioritization; the candidate uplink grant is addressed to a Temporary C-RNTI, or, the candidate uplink grant is received in a random access response (RAR), or, the candidate uplink grant is associated with an MSGA payload.

In one subembodiment, a MAC entity of the first node is not configured with lch-basedPrioritization; the candidate uplink grant is dynamically received on a PDCCH, or, the candidate uplink grant is received in a Random Access Response (RAR), or, the candidate uplink grant is associated with an MSGA payload.

In one embodiment, a position of the first control information on a PUSCH corresponding to the first uplink grant is predefined.

In one embodiment, a position of the first control information on a PUSCH corresponding to the first uplink grant is configured by RRC signaling.

In one embodiment, a position of the first control information on a PUSCH corresponding to the first uplink grant is calculated.

In one embodiment, the first control information is transmitted in a physical layer channel.

In one embodiment, the first control information is multiplexed in a physical layer channel.

In one embodiment, the first control information is transmitted on a PUSCH.

In one embodiment, the first control information occupies PUSCH resources.

In one embodiment, the first control information occupies PUSCH resources of the first uplink grant.

In one embodiment, the first control information is part of bits in a PUSCH transmission.

In one embodiment, the first control information is a piece of Uplink Control Information (UCI).

In one embodiment, the first control information is a CG-UCI.

In one embodiment, the first control information is an Unused Transmission Occasion (UTO)-UCI.

In one embodiment, the number of bits occupied by the first control information is fixed.

In one embodiment, the number of bits occupied by the first control information is configurable.

In one embodiment, the number of bits occupied by the first control information is predefined.

In one embodiment, the number of bits occupied by the first control information is default.

In one embodiment, the first control information comprises a bitmap.

In one embodiment, the first control information comprises a bitmap, any bit in the bitmap corresponding to an uplink grant.

In one subembodiment, if one bit in the bitmap in the first control information is set to 1, the first control information indicates that an uplink grant corresponding to the one bit is unused; if one bit in the bitmap in the first control information is set to 0, the first control information indicates that an uplink grant corresponding to the one bit is not unused.

In one subembodiment, if one bit in the bitmap in the first control information is set to 0, the first control information indicates that an uplink grant corresponding to the one bit is unused; if one bit in the bitmap in the first control information is set to 1, the first control information indicates that an uplink grant corresponding to the one bit is not unused.

In one embodiment, the first control information is a bitmap.

In one embodiment, the first control information is a bitmap, any bit in the first control information corresponding to an uplink grant configured by the first message.

In one embodiment, the first control information is a bitmap, any bit in the first control information being not reserved.

In one embodiment, the method above improves the flexibility of resource scheduling.

In one embodiment, the first control information is a bitmap, at least one bit in the first control information being reserved.

In one embodiment, the method avoids indicating whether an uplink grant is unused too early.

In one embodiment, the above method reduces monitoring complexity.

In one embodiment, the above method reduces the probability of incorrect decoding.

In one embodiment, a candidate for an indication of the first control information for each of the K2 uplink grant(s) comprises one of unused or not unused.

In one embodiment, the first control information indicates at least one uplink grant of the K2 uplink grant(s) as unused.

In one embodiment, the first control information indicates any of the K2 uplink grant(s) as either unused or not unused.

In one embodiment, unused/not unused means: not to be used/to be used.

In one embodiment, unused/not unused means: won't be used/will be used.

In one embodiment, unused/not unused means: needn't be reserved/need to be reserved.

In one embodiment, unused/not unused means: needn't/need.

In one embodiment, unused/not unused means: unused/used.

In one embodiment, K2 is variable.

In one subembodiment, K2 is configurable.

In one subembodiment, the above method saves signaling overhead.

In one subembodiment, the above method improves resource utilization.

In one subembodiment, K2 is configured by RRC signaling.

In one embodiment, K2 is fixed.

In one subembodiment, K2 is pre-defined.

In one subembodiment, K2 is default.

In one subembodiment, K2 does not vary with the configuration of RRC signaling.

In one subembodiment, the above method reduces complexity of blind detection.

In one subembodiment, the above method reduces erroneous delivery due to missed detection.

In one subembodiment, the above method reduces the impact on the protocol.

In one embodiment, K2 is not greater than a number of uplink grants in a configuration period.

In one embodiment, K2 is less than a number of uplink grants in a configuration period.

In one embodiment, K2 is greater than a number of uplink grants in a configuration period.

In one embodiment, whether K2 is greater than a number of uplink grants in a configuration period is configured by the base station.

In one embodiment, K2 is a size of the first bitmap in the first control information.

In one embodiment, K2 is a number of bits occupied by the first bitmap in the first control information.

In one embodiment, a maximum value of K2 is a number of uplink grants configured by the first message in a configuration period.

In one embodiment, a maximum value of K2 is a number of uplink grants configured by the first message in a plurality of configuration periods.

In one embodiment, K2 is a number of uplink grants configured by the first message in a configuration period.

In one embodiment, K2 is a number of uplink grants configured by the first message in a plurality of configuration periods.

In one embodiment, K2 is not greater than the number of bits occupied by the first control information; the first control information is a bitmap.

In one embodiment, K2 is equal to the number of bits occupied by the first control information; the first control information is a bitmap.

In one embodiment, the greater the number of uplink grants that overlap with the first symbol set among the uplink grants configured by the first message in a configuration period, the smaller K2 is; the uplink grants configured by the first message in the configuration period comprise at least part of the K2 uplink grant(s).

In one embodiment, the fewer the number of uplink grants later than the first uplink grant among the uplink grants configured by the first message in a configuration period, the smaller K2 is; the uplink grants configured by the first message in the configuration period comprise at least part of the K2 uplink grant(s).

In one embodiment, the first uplink grant is one of the uplink grants configured by the first message, and, each of the K2 uplink grant(s) is one of the uplink grants configured by the first message.

In one embodiment, time-domain resources allocated to the K2 uplink grant(s) are later than time-domain resources allocated to the first uplink grant.

In one embodiment, each of the K2 uplink grant(s) is later in time domain than the first uplink grant.

In one embodiment, a time-domain location of any of the K2 uplink grant(s) is later than a time-domain location of the first uplink grant.

In one embodiment, a time-domain location of any of the K2 uplink grant(s) does not overlap with the first uplink grant.

In one embodiment, the K2 uplink grant(s) is(are) K2 consecutive uplink grants among the uplink grants configured by the first message.

In one embodiment, the K2 uplink grant(s) is(are) K2 consecutive uplink grants immediately following the first uplink grant among the uplink grants configured by the first message.

In one embodiment, the K2 uplink grant(s) is(are) K2 uplink grant(s) after the first uplink grant among the uplink grants configured by the first message being non-overlapped with the first symbol set.

In one embodiment, the K2 uplink grant(s) is(are) consecutive uplink grants configured by the first message.

In one embodiment, the K2 uplink grant(s) is(are) non-consecutive uplink grants configured by the first message.

In one embodiment, the K2 uplink grant(s) and the first uplink grant belong to a same configuration period.

In one embodiment, at least one of the K2 uplink grant(s) and the first uplink grant do not belong to a same configuration period.

In one embodiment, a time-domain location of the K2 uplink grant(s) is dependent on a time-domain location of uplink grants configured by the first message.

In one embodiment, the K2 uplink grant(s) is(are) K2 consecutive uplink grants configured by the first message following the first uplink grant.

In one embodiment, the K2 uplink grant(s) is(are) K2 valid uplink grants configured by the first message following the first uplink grant.

In one embodiment, the K2 uplink grant(s) is(are) K2 uplink grants configured by the first message following the first uplink grant.

In one embodiment, the K2 uplink grant(s) is(are) dependent on a time-domain location of the uplink grants configured by the first message and the number of bits occupied by the first control information.

In one embodiment, the K2 uplink grant(s) is(are) K2 consecutive uplink grants configured by the first message following the first uplink grant.

In one embodiment, the K2 uplink grant(s) is(are) K2 valid uplink grants configured by the first message following the first uplink grant.

In one embodiment, a time-domain location of the K2 uplink grant(s) is dependent on a time-domain location of uplink grants configured by the first message and a location of the first symbol set.

In one embodiment, K2 is dependent on a time-domain location of uplink grants configured by the first message.

In one embodiment, K2 is dependent on a time-domain location of the first uplink grant among the uplink grants configured by the first message.

In one embodiment, the K2 is dependent on a number of uplink grant(s) among the uplink grants configured by the first message having a time-domain location later than the first uplink grant.

In one embodiment, the K2 is equal to a number of uplink grant(s) among the uplink grants configured by the first message having a time-domain location later than the first uplink grant.

In one embodiment, the K2 is no greater than a number of uplink grant(s) among the uplink grants configured by the first message having a time-domain location later than the first uplink grant.

In one embodiment, the K2 is dependent on a number of uplink grant(s) among the uplink grants configured by the first message having a time-domain location later than the first uplink grant and falling within a same configuration period as the first uplink grant.

In one embodiment, the K2 is equal to a number of uplink grant(s) among the uplink grants configured by the first message having a time-domain location later than the first uplink grant and falling within a same configuration period as the first uplink grant.

In one embodiment, the K2 is no greater than a number of uplink grant(s) among the uplink grants configured by the first message having a time-domain location later than the first uplink grant and falling within a same configuration period as the first uplink grant.

In one embodiment, the K2 is dependent on a number of uplink grant(s) among the uplink grants configured by the first message having a time-domain location later than the first uplink grant and falling within the first time interval.

In one embodiment, the K2 is equal to a number of uplink grant(s) among the uplink grants configured by the first message having a time-domain location later than the first uplink grant and falling within the first time interval.

In one embodiment, the K2 is no greater than a number of uplink grant(s) among the uplink grants configured by the first message having a time-domain location later than the first uplink grant and falling within the first time interval.

In one embodiment, the K2 is dependent on a number of uplink grant(s) among the uplink grants configured by the first message having a time-domain location later than the first uplink grant and no earlier than a first time.

In one embodiment, the K2 is equal to a number of uplink grant(s) among the uplink grants configured by the first message having a time-domain location later than the first uplink grant and no earlier than a first time.

In one embodiment, the K2 is no greater than a number of uplink grant(s) among the uplink grants configured by the first message having a time-domain location later than the first uplink grant and no earlier than a first time.

In one embodiment, if a time-domain location of one uplink grant of the uplink grants configured by the first message is earlier than the first uplink grant, the first control information does not indicate the one uplink grant.

In one embodiment, only if a time-domain location of one uplink grant of the uplink grants configured by the first message is later than the first uplink grant, it is likely that the first control information indicates the one uplink grant.

In one embodiment, K2 is dependent on a time-domain location of uplink grants configured by the first message and a location of the first symbol set.

In one embodiment, K2 is dependent on a time-domain location of the first uplink grant among the uplink grants configured by the first message and a location of the first symbol set.

In one embodiment, K2 is dependent on a number of uplink grant(s) among the uplink grants configured by the first message having a time-domain location later than the first uplink grant and being non-overlapped with the first symbol set.

In one embodiment, K2 is equal to a number of uplink grant(s) among the uplink grants configured by the first message having a time-domain location later than the first uplink grant and being non-overlapped with the first symbol set.

In one embodiment, K2 is no greater than a number of uplink grant(s) among the uplink grants configured by the first message having a time-domain location later than the first uplink grant and being non-overlapped with the first symbol set.

In one embodiment, K2 is dependent on a number of uplink grant(s) among the uplink grants configured by the first message having a time-domain location later than the first uplink grant and falling within a same configuration period as the first uplink grant and being non-overlapped with the first symbol set.

In one embodiment, K2 is equal to a number of uplink grant(s) among the uplink grants configured by the first message having a time-domain location later than the first uplink grant and falling within a same configuration period as the first uplink grant and being non-overlapped with the first symbol set.

In one embodiment, K2 is no greater than a number of uplink grant(s) among the uplink grants configured by the first message having a time-domain location later than the first uplink grant and falling within a same configuration period as the first uplink grant and being non-overlapped with the first symbol set.

In one embodiment, K2 is dependent on a number of uplink grant(s) among the uplink grants configured by the first message having a time-domain location later than the first uplink grant and falling within the first time interval and being non-overlapped with the first symbol set.

In one embodiment, K2 is equal to a number of uplink grant(s) among the uplink grants configured by the first message having a time-domain location later than the first uplink grant and falling within the first time interval and being non-overlapped with the first symbol set.

In one embodiment, K2 is no greater than a number of uplink grant(s) among the uplink grants configured by the first message having a time-domain location later than the first uplink grant and falling within the first time interval and being non-overlapped with the first symbol set.

In one embodiment, K2 is dependent on a number of uplink grant(s) among the uplink grants configured by the first message having a time-domain location later than the first uplink grant and no earlier than a first time and being non-overlapped with the first symbol set.

In one embodiment, K2 is equal to a number of uplink grant(s) among the uplink grants configured by the first message having a time-domain location later than the first uplink grant and no earlier than a first time and being non-overlapped with the first symbol set.

In one embodiment, K2 is no greater than a number of uplink grant(s) among the uplink grants configured by the first message having a time-domain location later than the first uplink grant and no earlier than a first time and being non-overlapped with the first symbol set.

In one embodiment, if one uplink grant among the uplink grants configured by the first message having a time-domain location later than the first uplink grant is overlapped with the first symbol set, the first control information does not indicate the one uplink grant.

In one embodiment, only if one uplink grant among the uplink grants configured by the first message having a time-domain location later than the first uplink grant is non-overlapped with the first symbol set, it is likely that the first control information indicates the one uplink grant.

In one embodiment, the symbol is a single-carrier symbol.

In one embodiment, the symbol is a multi-carrier symbol.

In one embodiment, the symbol is an Orthogonal Frequency Division Multiplexing (OFDM) Symbol.

In one embodiment, the symbol is a Single Carrier—Frequency Division Multiple Access (SC-FDMA) symbol.

In one embodiment, the symbol is a Discrete Fourier Transform Spread OFDM (DFT-S-OFDM) symbol.

In one embodiment, the symbol is a Filter Bank Multi Carrier (FBMC) symbol.

In one embodiment, the being overlapped with means to overlap with.

In one embodiment, the being overlapped with means to fully overlap with.

In one embodiment, the being overlapped with means to partially overlap with.

In one embodiment, the being overlapped with means to at least partially overlap with.

In one embodiment, the being overlapped with means being non-orthogonal to.

In one embodiment, the being overlapped with means comprising the same time-domain resources.

In one embodiment, the being non-overlapped with means being orthogonal to.

In one embodiment, the being non-overlapped with means not comprising the same time-domain resources.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises anode 203 and another node 204. The node 203 provides UE 201 oriented user plane and control plane terminations. The node 203 can be connected to other node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is an ng-eNB.

In one embodiment, the node 203 is an en-gNB.

In one embodiment, the node 203 is a Centralized Unit (CU).

In one embodiment, the node 203 is a Distributed Unit (DU).

In one embodiment, the node 203 is a UE.

In one embodiment, the node 203 is a relay.

In one embodiment, the node 203 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a CU.

In one embodiment, the base station comprises a DU.

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3. The layer 1 (L1) is the lowest layer which performs various signal processing functions of PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat Request (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC306.

In one embodiment, the first message in the present application is generated by the MAC302 or the MAC352.

In one embodiment, the first message in the present application is generated by the PHY301 or the PHY351.

In one embodiment, the second message in the present application is generated by the RRC306.

In one embodiment, the second message in the present application is generated by the MAC302 or the MAC352.

In one embodiment, the second message in the present application is generated by the PHY301 or the PHY351.

In one embodiment, the first control information in the present application is generated by the RRC306.

In one embodiment, the first control information in the present application is generated by the MAC302 or the MAC352.

In one embodiment, the first control information in the present application is generated by the PHY301 or the PHY351.

### Embodiment 4

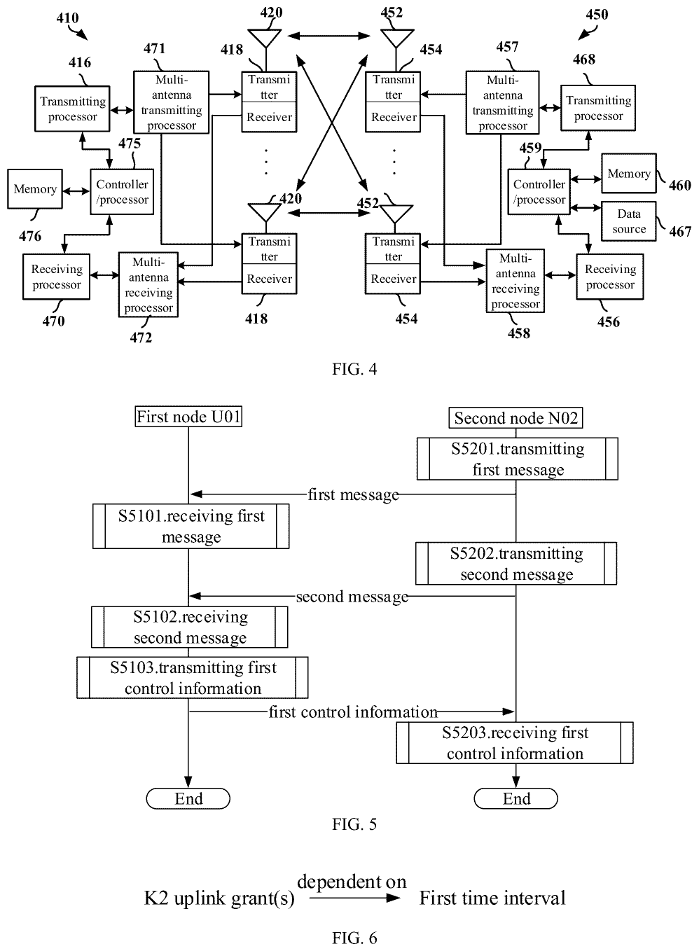

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first message, the first message configuring uplink grants, any two uplink grants configured by the first message being temporally non-overlapped; and receives a second message, the second message indicating a first symbol set; and transmits first control information in a first uplink grant, the first control information indicating whether K2 uplink grant(s) is(are) unused, the first uplink grant and the K2 uplink grant(s) being configured by the first message, the K2 uplink grant(s) being after the first uplink grant; herein, the K2 uplink grant(s) is(are) dependent on at least a former of a time-domain location of uplink grants configured by the first message or a location of the first symbol set; K2 being a positive integer.

In one embodiment, the first communication device 450 comprises a memory that stores a computer readable instruction program. The computer readable instruction program generates actions when executed by at least one processor. The actions include: receiving a first message, the first message configuring uplink grants, any two uplink grants configured by the first message being temporally non-overlapped; and receiving a second message, the second message indicating a first symbol set; and transmitting first control information in a first uplink grant, the first control information indicating whether K2 uplink grant(s) is(are) unused, the first uplink grant and the K2 uplink grant(s) being configured by the first message, the K2 uplink grant(s) being after the first uplink grant; herein, the K2 uplink grant(s) is(are) dependent on at least a former of a time-domain location of uplink grants configured by the first message or a location of the first symbol set; K2 being a positive integer.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first message, the first message configuring uplink grants, any two uplink grants configured by the first message being temporally non-overlapped; and transmits a second message, the second message indicating a first symbol set; and receives first control information, the first control information indicating whether K2 uplink grant(s) is(are) unused, the first uplink grant and the K2 uplink grant(s) being configured by the first message, the K2 uplink grant(s) being after the first uplink grant; herein, a receiver of the first message transmits the first control information in a first uplink grant; the K2 uplink grant(s) is(are) dependent on at least a former of a time-domain location of uplink grants configured by the first message or a location of the first symbol set; K2 being a positive integer.

In one embodiment, the second communication device 410 comprises a memory that stores a computer readable instruction program. The computer readable instruction program generates actions when executed by at least one processor. The actions include: transmitting a first message, the first message configuring uplink grants, any two uplink grants configured by the first message being temporally non-overlapped; and transmitting a second message, the second message indicating a first symbol set; and receiving first control information, the first control information indicating whether K2 uplink grant(s) is(are) unused, the first uplink grant and the K2 uplink grant(s) being configured by the first message, the K2 uplink grant(s) being after the first uplink grant; herein, a receiver of the first message transmits the first control information in a first uplink grant; the K2 uplink grant(s) is(are) dependent on at least a former of a time-domain location of uplink grants configured by the first message or a location of the first symbol set; K2 being a positive integer.

In one embodiment, at least one of the antenna 452, the receiver 454, the receiving processor 456 or the controller/processor 459 is used for receiving a first message.

In one embodiment, at least one of the antenna 420, the transmitter 418, the transmitting processor 416 or the controller/processor 475 is used for transmitting a first message.

In one embodiment, at least one of the antenna 452, the receiver 454, the receiving processor 456 or the controller/processor 459 is used for receiving a second message.

In one embodiment, at least one of the antenna 420, the transmitter 418, the transmitting processor 416 or the controller/processor 475 is used for transmitting a second message.

In one embodiment, at least one of the antenna 452, the transmitter 454, the transmitting processor 468 or the controller/processor 459 is used for transmitting first control information.

In one embodiment, at least one of the antenna 420, the receiver 418, the receiving processor 470 or the controller/processor 475 is used for receiving first control information.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a base station.

In one embodiment, the first communication device 450 is a relay device.

In one embodiment, the second communication device 410 is a UE.

In one embodiment, the second communication device 410 is a base station.

In one embodiment, the second communication device 410 is a relay device.

### Embodiment 5

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first message in step S5101, the first message configuring uplink grants, any two uplink grants configured by the first message being temporally non-overlapped; and receives a second message in step S5102, the second message indicating a first symbol set; and transmits first control information in a first uplink grant in step S5103, the first control information indicating whether K2 uplink grant(s) is(are) unused, the first uplink grant and the K2 uplink grant(s) being configured by the first message, the K2 uplink grant(s) being after the first uplink grant.

The second node N02 transmits the first message in step S5201; and transmits the second message in step S5202; and receives the first control information in step S5203.

In Embodiment 5, the K2 uplink grant(s) is(are) dependent on at least a former of a time-domain location of uplink grants configured by the first message or a location of the first symbol set; K2 being a positive integer.

In one embodiment, the first node U01 is a UE.

In one embodiment, the first node U01 is a base station.

In one embodiment, the first node U01 is a relay device.

In one embodiment, the second node N02 is a base station.

In one embodiment, the second node N02 is a UE.

In one embodiment, the second node N02 is a relay device.

In one embodiment, the first node U01 is a UE, and the second node N02 is a base station.

In one embodiment, the first node U01 is a UE, and the second node N02 is a UE.

In one embodiment, the first node U01 is a base station, and the second node N02 is a base station.

In one embodiment, the K2 uplink grant(s) is(are) dependent on at least a former of a time-domain location of uplink grants configured by the first message or a location of the first symbol set.

In one embodiment, the K2 uplink grant(s) is(are) dependent on a first time interval.

In one embodiment, the K2 uplink grant(s) is(are) dependent on the number of bits occupied by the first control information; the first control information is a bitmap.

In one embodiment, the K2 uplink grant(s) is(are) dependent on at least a former of a time-domain location of uplink grants configured by the first message or a location of the first symbol set or a first time interval or a number of bits occupied by the first control information.

In one embodiment, the K2 uplink grant(s) is(are) uplink grant(s) among the uplink grants configured by the first message having a time-domain location later than the first uplink grant and falling within the first time interval.

In one embodiment, the K2 uplink grant(s) is(are) uplink grant(s) among the uplink grants configured by the first message having a time-domain location later than the first uplink grant and falling within the first time interval and being non-overlapped with the first symbol set.

### Embodiment 6

Embodiment 6 illustrates a schematic diagram of K2 uplink grant(s) depending on a first time interval according to one embodiment of the present application, as shown in FIG. 6.

In Embodiment 6, the K2 uplink grant(s) is(are) dependent on a first time interval; a start of the first time interval is related to a time-domain location of the first uplink grant, and a length of the first time interval is configurable.

In one embodiment, the K2 uplink grant(s) is(are) K2 uplink grant(s) after the first uplink grant among the uplink grants configured by the first message being non-overlapped with the first symbol set and falling within the first time interval.

In one embodiment, the K2 uplink grant(s) is(are) K2 consecutive uplink grants belonging to the first time interval among the uplink grants configured by the first message.

In one embodiment, a time-domain location of any of the K2 uplink grant(s) falls within the first time interval.

In one embodiment, the longer the first time interval is, the greater K2 is; the uplink grants configured by the first message in the one configuration period include at least part of the K2 uplink grants.

In one embodiment, the first time interval is configured by an RRC message.

In one embodiment, the first time interval is related to a time interval between two adjacent uplink grants configured by the first message.

In one embodiment, the first time interval is a positive integer number of time interval(s) between two adjacent uplink grants configured by the first message.

In one embodiment, a start of the first time interval is a start of the time-domain location of the first uplink grant.

In one embodiment, a start of the first time interval is an end of the time-domain location of the first uplink grant.

In one embodiment, a start of the first time interval is an instance of time after X1 symbols following an end of the time-domain location of the first uplink grant; X1 being pre-defined.

In one embodiment, a start of the first time interval is related to a start of the time-domain location of the first uplink grant.

In one embodiment, a start of the first time interval is related to an end of the time-domain location of the first uplink grant.

### Embodiment 7

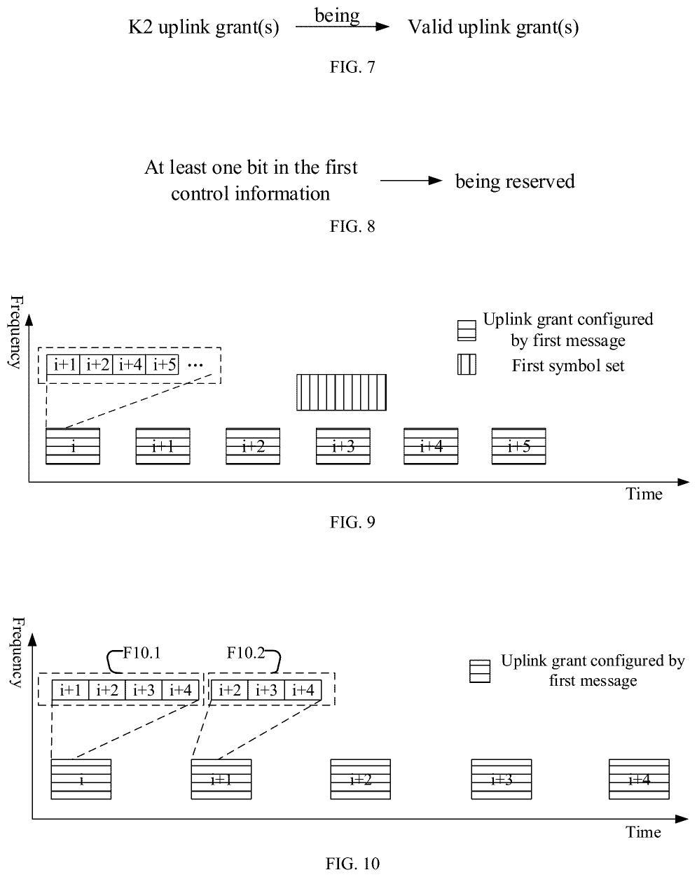

Embodiment 7 illustrates a schematic diagram of K2 uplink grant(s) being valid uplink grant(s) according to one embodiment of the present application, as shown in FIG. 7.

In Embodiment 7, the K2 uplink grant(s) is(are) valid uplink grant(s); the valid uplink grant(s) satisfies/satisfy at least one condition of being non-overlapped with the first symbol set or belonging to the first time interval or being later than the first uplink grant in time domain.

In one embodiment, any one of the K2 uplink grant(s) is a valid uplink grant.

In one embodiment, the valid uplink grant is an uplink grant that does not overlap with the first symbol set.

In one embodiment, the valid uplink grant is an uplink grant belonging to the first time interval.

In one embodiment, the valid uplink grant is an uplink grant that is later in time domain than the first uplink grant.

In one embodiment, the valid uplink grant is an uplink grant that belongs to the first time interval and does not overlap with the first symbol set.

In one embodiment, the valid uplink grant is an uplink grant that is later in time domain than the first uplink grant and belongs to the first time interval and does not overlap with the first symbol set.

In one embodiment, the valid uplink grant is an uplink grant that is later in time domain than the first uplink grant and does not overlap with the first symbol set.

In one embodiment, the first control information indicates K2 valid uplink grants; the number of bits occupied by the first control information is K2.

In one embodiment, the number of bits occupied by the first control information varies with the number of valid uplink grants.

In one embodiment, the first control information indicates K2 valid uplink grants; K2 is not greater than the number of bits occupied by the first control information.

In one embodiment, if K2 is less than the number of bits occupied by the first control information, at least one bit in the first control information being reserved.

### Embodiment 8

Embodiment 8 illustrates a schematic diagram of at least one bit in first control information being reserved according to one embodiment of the present application, as shown in FIG. 8.

In Embodiment 8, the first control information is a bitmap, a number of bits occupied by the first control information is greater than K2, and at least one bit in the first control information is reserved.

In one embodiment, the number of bits occupied by the first control information is fixed.

In one embodiment, the number of bits occupied by the first control information is pre-defined.

In one embodiment, the number of bits occupied by the first control information is not dynamically varied.

In one embodiment, the bit(s) being reserved in the first control information is(are) mapped to an uplink grant.

In one embodiment, the bit(s) being reserved in the first control information is(are) not indicative of whether corresponding uplink grant(s) is(are) unused.

In one embodiment, the bit(s) being reserved in the first control information is(are) not interpreted by the second node.

In one embodiment, the value of the bit(s) being reserved in the first control information is not used to indicate whether unused or not unused.

In one embodiment, whether the bit(s) being reserved in the first control information is(are) set to 0 or 1 is determined by the UE implementation.

In one embodiment, whether the bit(s) being reserved in the first control information is(are) set to 0 or 1 is pre-defined.

In one embodiment, the bit(s) being reserved in the first control information is(are) set to 0.

In one embodiment, the bit(s) being reserved in the first control information is(are) set to 1.

In one embodiment, the time-domain location of an uplink grant configured by the first message being overlapped with a location of the first symbol set is used to determine that a bit corresponding to the uplink grant in the first control information is reserved.

In one embodiment, the number of uplink grant(s) in the first time interval being less than the number of bits occupied by the first control information is used to determine that a bit corresponding to the uplink grant in the first control information is reserved.

### Embodiment 9

Embodiment 9 illustrates a schematic diagram of uplink grants configured by a first message and a first symbol set according to one embodiment of the present application, as shown in FIG. 9. In FIG. 9, the horizontal axis represents time and the vertical axis represents frequency; each box filled with horizontal lines represents an uplink grant configured by the first message; the box filled with vertical lines represents the first symbol set; the dashed rectangle represents first control information; an uplink grant i, an uplink grant i+1, an uplink grant i+2, an uplink grant i+3, an uplink grant i+4, and an uplink grant i+5 are six adjacent uplink grants; the first uplink grant is uplink grant i; the uplink grant i+3 and the first symbol set are overlapped.

In Embodiment 9, whether an uplink grant configured by the first message is one of the K2 uplink grants depends on whether a time-domain location of the uplink grant configured by the first message and a location of the first symbol set are overlapped.

In one embodiment, when a time-domain location of one of the K2 uplink grant(s) and the location of the first symbol set are non-overlapped, the uplink grant is the one of the K2 uplink grant(s); when a time-domain location of one of the K2 uplink grant(s) and the location of the first symbol set are overlapped, the uplink grant is not one of the K2 uplink grant(s).

In one embodiment, if an uplink grant configured by the first message is one of the K2 uplink grant(s), the first control information indicates whether the uplink grant is unused; if an uplink grant configured by the first message is not one of the K2 uplink grant(s), the first control information does not indicate whether the uplink grant is unused.

In one embodiment, if the first control information indicates whether an uplink grant is unused, one bit in a bitmap in the first control information corresponds to the uplink grant; if the first control information does not indicate whether an uplink grant is unused, any bit in a bitmap in the first control information does not correspond to the uplink grant.

In one embodiment, the first bit in the first control information corresponds to the uplink grant i+1, the second bit corresponds to the uplink grant i+2, the third bit corresponds to the uplink grant i+4, the fourth bit corresponds to the uplink grant i+5, and so on; and any bit in the first control information does not correspond to the uplink grant i+3.

In one embodiment, this embodiment does not limit the manner in which the first control information is implemented.

In one embodiment, this embodiment does not limit the number of bits occupied by the first control information.

In one embodiment, this embodiment does not limit the number of bits occupied by a bitmap in the first control information.

In one embodiment, this embodiment does not limit the time-frequency location of the first control information in the first uplink grant.

In one embodiment, this embodiment does not limit whether the uplink grants configured by the first message occupy the same frequency-domain resources.

In one embodiment, this embodiment does not limit whether the lengths of time-domain resources occupied by the uplink grants configured by the first message are the same.

In one embodiment, this embodiment does not limit whether the lengths of time domain between adjacent uplink grants configured by the first message are the same.

In one embodiment, this embodiment does not limit whether the six uplink grants belong to the same configuration period.

In one embodiment, this embodiment does not limit the number of uplink grants in each configuration period configured by the first message.

### Embodiment 10

Embodiment 10 illustrates a schematic diagram of K2 depending on a time-domain location of uplink grants configured by a first message according to one embodiment of the present application, as shown in FIG. 10. In FIG. 10, the horizontal axis represents time and the vertical axis represents frequency; each box filled with horizontal lines represents an uplink grant configured by the first message; an uplink grant i, an uplink grant i+1, an uplink grant i+2, an uplink grant i+3, and an uplink grant i+4 are five adjacent uplink grants.

In Embodiment 10, K2 is dependent on the time-domain location of uplink grants configured by the first message; K2 is equal to the number of bits occupied by the first control information; the first control information is a bitmap.

In one embodiment, K2 is the number of bits occupied by the first control information.

In one embodiment, the number of bits occupied by the first control information is variable.

In one embodiment, the number of bits occupied by the first control information is dynamically varied.

In one embodiment, the K2 is dependent on a number of uplink grant(s) among the uplink grants configured by the first message having a time-domain location later than the first uplink grant and falling within a same configuration period as the first uplink grant.

In one embodiment, the K2 is dependent on a number of uplink grant(s) among the uplink grants configured by the first message having a time-domain location later than the first uplink grant and falling within the first time interval.

In one embodiment, the K2 is dependent on a number of uplink grant(s) among the uplink grants configured by the first message having a time-domain location later than the first uplink grant and no earlier than a first time.

In one embodiment, the first uplink grant is the uplink grant i; the dashed box F10.1 denotes first control information, bits in the first control information correspond sequentially to the uplink grant i+1, the uplink grant i+2, the uplink grant i+3, and the uplink grant i+4, K2 being equal to 4.

In one embodiment, the first uplink grant is the uplink grant i+1; the dashed box F10.2 denotes first control information, bits in the first control information correspond sequentially to the uplink grant i+2, the uplink grant i+3, and the uplink grant i+4, K2 being equal to 4.

In one embodiment, K2 depends on whether the uplink grant i, the uplink grant i+1, the uplink grant i+2, the uplink grant i+3, and the uplink grant i+4 are overlapped with the first symbol set; none of the uplink grant i, the uplink grant i+1, the uplink grant i+2, the uplink grant i+3, and the uplink grant i+4 is overlapped with the first symbol set.

In one subembodiment, if the uplink grant i+2 is overlapped with the first symbol set, the first uplink grant is the uplink grant i; the dashed box F10.1 denotes first control information, bits in the first control information correspond sequentially to the uplink grant i+1, the uplink grant i+3, and the uplink grant i+4, K2 being equal to 3.

In one embodiment, K2 does not depend on whether the uplink grant i, the uplink grant i+1, the uplink grant i+2, the uplink grant i+3 and the uplink grant i+4 are overlapped with the first symbol set.

In one subembodiment, if the uplink grant i+2 is overlapped with the first symbol set, the first uplink grant is the uplink grant i; the dashed box F10.1 denotes first control information, bits in the first control information correspond sequentially to the uplink grant i+1, the uplink grant i+2, the uplink grant i+3, and the uplink grant i+4, K2 being equal to 4, and a bit corresponding to the uplink grant i+2 being reserved.

In one subembodiment, if the uplink grant i+2 is overlapped with the first symbol set, the first uplink grant is the uplink grant i; the dashed box F10.1 denotes first control information, bits in the first control information correspond sequentially to the uplink grant i+1, the uplink grant i+3, the uplink grant i+4, and the uplink grant i+5, K2 being equal to 4.

In one embodiment, this embodiment does not limit the manner in which the first control information is implemented.

In one embodiment, this embodiment does not limit the number of bits occupied by the first control information.

In one embodiment, this embodiment does not limit the number of bits occupied by a bitmap in the first control information.

In one embodiment, this embodiment does not limit the time-frequency location of the first control information in the first uplink grant.

In one embodiment, this embodiment does not limit whether the uplink grants configured by the first message occupy the same frequency-domain resources.

In one embodiment, this embodiment does not limit whether the lengths of time-domain resources occupied by the uplink grants configured by the first message are the same.

In one embodiment, this embodiment does not limit whether the lengths of time domain between adjacent uplink grants configured by the first message are the same.

In one embodiment, this embodiment does not limit whether the five uplink grants belong to the same configuration period.

In one embodiment, this embodiment does not limit the number of uplink grants in each configuration period configured by the first message.

### Embodiment 11

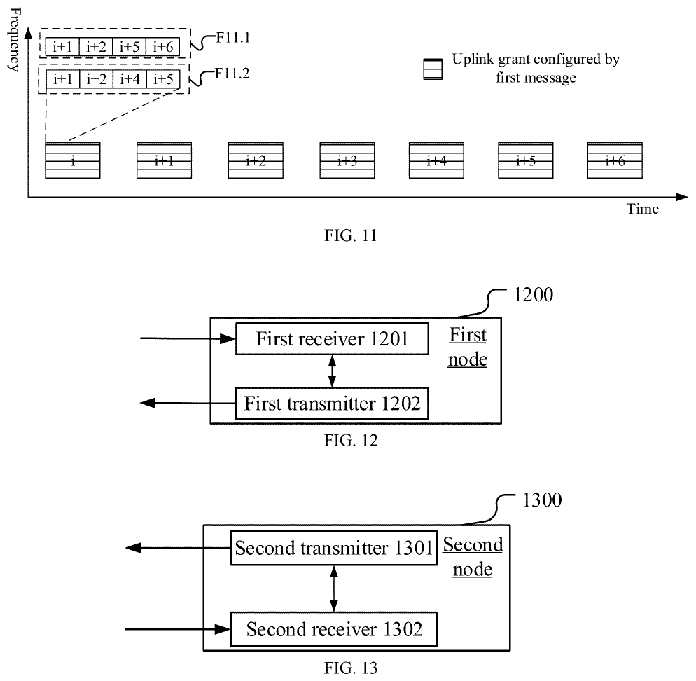

Embodiment 11 illustrates a schematic diagram of K2 uplink grant(s) depending on a time-domain location of uplink grants configured by a first message according to one embodiment of the present application, as shown in FIG. 11. In FIG. 11, the horizontal axis represents time and the vertical axis represents frequency; each box filled with horizontal lines represents an uplink grant configured by the first message; an uplink grant i, an uplink grant i+1, an uplink grant i+2, an uplink grant i+3, an uplink grant i+4, an uplink grant i+5 and an uplink grant i+6 are seven adjacent uplink grants.

In Embodiment 11, the K2 uplink grant(s) is(are) dependent on a time-domain location of uplink grants configured by the first message; the first control information is a bitmap.

In one embodiment, the number of bits occupied by the first control information is fixed.

In one embodiment, the number of bits occupied by the first control information is persistently configured.

In one embodiment, the number of bits occupied by the first control information is semi-persistently configured.

In one embodiment, the dashed box F11.1 denotes first control information, bits in the first control information correspond sequentially to the uplink grant i+1, the uplink grant i+2, the uplink grant i+5, and the uplink grant i+6, and any of the bits in the first control information does not correspond to the uplink grant i+3 and uplink grant i+4.

In one embodiment, the dashed box F11.2 denotes first control information, bits in the first control information correspond sequentially to the uplink grant i+1, the uplink grant i+2, the uplink grant i+4, and the uplink grant i+5, and any of the bits in the first control information does not correspond to the uplink grant i+3.

In one embodiment, this embodiment does not limit the manner in which the first control information is implemented.

In one embodiment, this embodiment does not limit the number of bits occupied by the first control information.

In one embodiment, this embodiment does not limit the number of bits occupied by a bitmap in the first control information.

In one embodiment, this embodiment does not limit the time-frequency location of the first control information in the first uplink grant.

In one embodiment, this embodiment does not limit whether the uplink grants configured by the first message occupy the same frequency-domain resources.

In one embodiment, this embodiment does not limit whether the lengths of time-domain resources occupied by the uplink grants configured by the first message are the same.

In one embodiment, this embodiment does not limit whether the lengths of time domain between adjacent uplink grants configured by the first message are the same.

In one embodiment, this embodiment does not limit whether the seven uplink grants belong to the same configuration period.

In one embodiment, this embodiment does not limit the number of uplink grants in each configuration period configured by the first message.

### Embodiment 12

Embodiment 12 illustrates a structure block diagram of a processing device used in a first node according to one embodiment of the present application, as shown in FIG. 12. In FIG. 12, a processing device 1200 in a first node is comprised of a first receiver 1201 and a first transmitter 1202.

The first receiver 1201 receives a first message, the first message configuring uplink grants, any two uplink grants configured by the first message being temporally non-overlapped; and receives a second message, the second message indicating a first symbol set;

the first transmitter 1202 transmits first control information in a first uplink grant, the first control information indicating whether K2 uplink grant(s) is(are) unused, the first uplink grant and the K2 uplink grant(s) being configured by the first message, the K2 uplink grant(s) being after the first uplink grant.

In Embodiment 12, the K2 uplink grant(s) is(are) dependent on at least a former of a time-domain location of uplink grants configured by the first message or a location of the first symbol set; K2 being a positive integer.

In one embodiment, the K2 uplink grant(s) is(are) dependent on a first time interval; a start of the first time interval is related to a time-domain location of the first uplink grant, and a length of the first time interval is configurable.

In one embodiment, the first control information is a bitmap, a number of bits occupied by the first control information is greater than K2, and at least one bit in the first control information is reserved.

In one embodiment, the K2 uplink grant(s) is(are) dependent on the number of bits occupied by the first control information; the first control information is a bitmap.

In one embodiment, the K2 uplink grant(s) is(are) valid uplink grant(s); the valid uplink grant(s) satisfies/satisfy at least one condition of being non-overlapped with the first symbol set or belonging to the first time interval or being later than the first uplink grant in time domain.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

### Embodiment 13

Embodiment 13 illustrates a structure block diagram of a processing device used in a second node according to one embodiment of the present application, as shown in FIG. 13. In FIG. 13, a processing device 1300 in a second node is comprised of a second transmitter 1301 and a second receiver 1302.

The second transmitter 1301 transmits a first message, the first message configuring uplink grants, any two uplink grants configured by the first message being temporally non-overlapped; and transmits a second message, the second message indicating a first symbol set;

the second receiver 1302 receives first control information, the first control information indicating whether K2 uplink grant(s) is(are) unused, the first uplink grant and the K2 uplink grant(s) being configured by the first message, the K2 uplink grant(s) being after the first uplink grant.

In Embodiment 13, a receiver of the first message transmits the first control information in a first uplink grant; the K2 uplink grant(s) is(are) dependent on at least a former of a time-domain location of uplink grants configured by the first message or a location of the first symbol set; K2 being a positive integer.

In one embodiment, the K2 uplink grant(s) is(are) dependent on a first time interval; a start of the first time interval is related to a time-domain location of the first uplink grant, and a length of the first time interval is configurable.

In one embodiment, the first control information is a bitmap, a number of bits occupied by the first control information is greater than K2, and at least one bit in the first control information is reserved.

In one embodiment, the K2 uplink grant(s) is(are) dependent on the number of bits occupied by the first control information; the first control information is a bitmap.

In one embodiment, the K2 uplink grant(s) is(are) valid uplink grant(s); the valid uplink grant(s) satisfies/satisfy at least one condition of being non-overlapped with the first symbol set or belonging to the first time interval or being later than the first uplink grant in time domain.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first message, the first message configuring uplink grants, any two uplink grants configured by the first message being temporally non-overlapped; and receiving a second message, the second message indicating a first symbol set; and
a first transmitter, transmitting first control information in a first uplink grant, the first control information indicating whether K2 uplink grant(s) is(are) unused, the first uplink grant and the K2 uplink grant(s) being configured by the first message, the K2 uplink grant(s) being after the first uplink grant;
wherein the K2 uplink grant(s) is(are) dependent on at least a former of a time-domain location of the uplink grants configured by the first message or a location of the first symbol set; K2 being a positive integer.

2. The first node according to claim 1, characterized in that the second message indicates the first symbol set in a time-domain resource for downlink transmission; the time-domain resource for downlink transmission referring to downlink slot(s); a tdd-UL-DL-ConfigurationCommon field is used to configure the time-domain resource for downlink transmission, or, a TDD-UL-DL-ConfigDedicated IE is used to configure the time-domain resource for downlink transmission.

3. The first node according to claim 1, characterized in that the first control information is a UTO-UCI; a number of bits occupied by the first control information is configurable.

4. The first node according to claim 1, characterized in that the first control information is a bitmap; if one bit in the bitmap in the first control information is set to 1, the first control information indicates that an uplink grant corresponding to the one bit is unused; if one bit in the bitmap in the first control information is set to 0, the first control information indicates that an uplink grant corresponding to the one bit is not unused.

5. The first node according to claim 1, characterized in that K2 is configured by an RRC signaling.

6. The first node according to claim 1, characterized in that K2 is equal to the number of bits occupied by the first control information; the first control information is a bitmap.

7. The first node according to claim 1, characterized in that the K2 uplink grant(s) is(are) dependent on the number of bits occupied by the first control information; the first control information is a bitmap.

8. The first node according to claim 1, characterized in that the K2 uplink grant(s) is(are) K2 uplink grant(s) not overlapped with the first symbol set after the first uplink grant among the uplink grants configured by the first message.

9. The first node according to claim 1, characterized in that the K2 uplink grant(s) is(are) consecutive uplink grants configured by the first message, or, the K2 uplink grant(s) is(are) non-consecutive uplink grants configured by the first message.

10. The first node according to claim 1, characterized in that the K2 uplink grant(s) is(are) dependent on the time-domain location of the uplink grants configured by the first message and the number of bits occupied by the first control information.

11. The first node according to claim 1, characterized in that whether an uplink grant configured by the first message is one of the K2 uplink grant(s) is dependent on whether a time-domain location of the uplink grant configured by the first message and the location of the first symbol set are overlapped.

12. The first node according to claim 11, characterized in that if an uplink grant configured by the first message is one of the K2 uplink grant(s), the first control information indicates whether the uplink grant is unused; if an uplink grant configured by the first message is not one of the K2 uplink grant(s), the first control information does not indicate whether the uplink grant is unused.

13. The first node according to claim 11, characterized in that if the first control information indicates whether an uplink grant is unused, one bit in a bitmap in the first control information corresponds to the uplink grant; if the first control information does not indicate whether an uplink grant is unused, any bit in a bitmap in the first control information does not correspond to the uplink grant.

14. The first node according to claim 1, characterized in that the K2 uplink grant(s) is(are) dependent on a first time interval; a start of the first time interval is related to a time-domain location of the first uplink grant, and a length of the first time interval is configurable.

15. The first node according to claim 1, characterized in that the first control information is a bitmap, a number of bits occupied by the first control information is greater than K2, and at least one bit in the first control information is reserved.

16. The first node according to claim 1, characterized in that the K2 uplink grant(s) is(are) dependent on the number of bits occupied by the first control information; the first control information is a bitmap.

17. The first node according to claim 1, characterized in that the K2 uplink grant(s) is(are) valid uplink grant(s); the valid uplink grant(s) satisfies/satisfy at least one condition of being non-overlapped with the first symbol set or belonging to the first time interval or being later than the first uplink grant in time domain.

18. The first node according to claim 17, characterized in that the K2 uplink grant(s) is(are) K2 valid uplink grant(s) after the first uplink grant configured by the first message.

19. A second node for wireless communications, comprising:
a second transmitter, transmitting a first message, the first message configuring uplink grants, any two uplink grants configured by the first message being temporally non-overlapped; and transmitting a second message, the second message indicating a first symbol set; and
a second receiver, receiving first control information, the first control information indicating whether K2 uplink grant(s) is(are) unused, the first uplink grant and the K2 uplink grant(s) being configured by the first message, the K2 uplink grant(s) being after the first uplink grant;
wherein a receiver of the first message transmits the first control information in a first uplink grant; the K2 uplink grant(s) is(are) dependent on at least a former of a time-domain location of the uplink grants configured by the first message or a location of the first symbol set; K2 being a positive integer.

20. A method in a first node for wireless communications, comprising:
receiving a first message, the first message configuring uplink grants, any two uplink grants configured by the first message being temporally non-overlapped; and receiving a second message, the second message indicating a first symbol set; and
transmitting first control information in a first uplink grant, the first control information indicating whether K2 uplink grant(s) is(are) unused, the first uplink grant and the K2 uplink grant(s) being configured by the first message, the K2 uplink grant(s) being after the first uplink grant;
wherein the K2 uplink grant(s) is(are) dependent on at least a former of a time-domain location of the uplink grants configured by the first message or a location of the first symbol set; K2 being a positive integer.
